(19) United States
(12) Patent Application Publication
(10) Pub. No.: US 2021/0174995 A1
(43) Pub. Date: Jun. 10, 2021

(54) SERVO-ACTUATED ROTARY MAGNETIC LATCHING MECHANISM AND METHOD

(71) Applicant: KING ABDULLAH UNIVERSITY OF SCIENCE AND TECHNOLOGY, Thuwal (SA)

(72) Inventors: Usman Amin FIAZ, College Park, MD (US); Jeff S. SHAMMA, Thuwal (SA)

(21) Appl. No.: 16/761,634

(22) PCT Filed: Oct. 25, 2018
(86) PCT No.: PCT/IB2018/058342

§ 371 Date: May 5, 2020

Related U.S. Application Data
(60) Provisional application No. 62/585,018, filed on Nov. 13, 2017.
(60) Provisional application No. 62/663,372, filed on Apr. 27, 2018.

(51) Int. Cl. H01F 7/14; H01F 7/02; H01F 7/04

(52) U.S. Cl. CPC H01F 7/145; H01F 7/04; H01F 7/0252

(57) ABSTRACT

A magnetic latching mechanism including a servo-motor configured to rotate an axle; a latching rotor attached to the axle and configured to rotate; and a pair of latching permanent magnets attached to the latching rotor. A north pole of a permanent magnet and a south pole of another permanent magnet of the pair are facing along a same direction.

### CROSS-REFERENCE TO RELATED APPLICATIONS

This application claims priority to U.S. Provisional patent Application No. 62/585,018, filed on Nov. 13, 2017, entitled “SERVO-ACTUATED LATCHING MECHANISM FOR PASSIVE MAGNETS,” and U.S. Provisional Patent Application No. 62/663,372, filed on Apr. 27, 2018, entitled “SERVO-ACTUATED ROTARY MAGNETIC LATCHING MECHANISM AND METHOD,” the disclosure of which is incorporated herein by reference in its entirety.

### BACKGROUND

### Technical Field

Embodiments of the subject matter disclosed herein generally relate to a magnetic latching mechanism, and more specifically, to methods and systems for allowing robots to magnetically latch to each other and be able to easily separate from the magnetic grip of each other.

### Discussion of the Background

Magnetic latching with its wide applications have been around for years. From decades ago to even recent years, extended research has been performed to develop a reliable, small and low-power consumption magnetic latching mechanism. There is no better latching mechanism then a magnetic one when considering the reliability and consistency with which the magnets interact with each other as well as with other ferrous objects. In the modern world, the magnets come in different variants, e.g., permanent magnets, electromagnets, and electropermanent magnets (EPMs) being the three main classes. Out of these three classes, the permanent magnets perform best in terms of power consumption (practically there is no power consumption), scalability and latching strength (see FIG. 1, where black indicates poor, gray indicates best, and white indicates acceptable). The part where the permanent magnets perform poorly comparative to the electromagnets and the EPMs is the latching control.

It is clear from FIG. 1 that the permanent magnets are the most economical and efficient form to use in miniature and small sized applications, where power consumption has to be kept at a minimum. However, the permanent magnets provide no control over their superior latching capabilities, i.e., there is no turn off signal that can be used to simply break or detach the latched components in an assembly.

Some methods have been used in recent years for achieving programmable, self-assembly, robots that use the strength of permanent magnets to perform autonomous latching tasks. Most of these methods utilize either electro-magnets or EPMs, which have the drawbacks of high power consumption and customized design requirements. For power efficient applications, the use of electromagnets is ruled out because of their hunger for power. For EPMs, there are other problems, such as, the lack of strong bonding (˜ in the order of Newtons) that is necessary for any application of practical/industrial interest. Another drawback of the existing magnetic latching mechanisms is the possible introduction of interference in local communication caused by the on/off latching activity of the EPM control circuit, which is basically a high frequency RC circuit (see, for example, Lily Robots, Mota Group, or the Pebbles robot at MIT).

Some research groups have however, used permanent magnets for strong bonding purposes (see, for example, the M-blocks at MIT), but their usefulness has only been in the making of the bonds. They have used a momentum driven, brushless motor mechanism for breaking the contact between two parties latched through the magnetic interaction of the permanent magnets, which is not as smooth or much of a direct breakage. Also the breakage for these robots involves the rotation of the whole agent (robot or bot) around one of its axis, which completely changes its orientation during a disassembly action.

However, in many applications, e.g., latching, perching, etc. in air using drones, rotating the entire robot is not desirable and sometimes not possible. A good magnetic latching mechanism is desired to have a very smooth detachment (undocking) of the latched components. Also, the face magnets for the M-blocks robots are placed at fixed positions and are static in nature, i.e., they are unable to change their polarity or position and thus, the bots have to pay a price in terms of their abrupt change in orientation for executing a bond break.

Therefore, there is a need for a magnetic latching mechanism that uses permanent magnets but at the same time exhibits a smooth undocking operation, without rotating the entire robot or bot.

### SUMMARY

According to an embodiment, there is a magnetic latching mechanism that includes a servo-motor configured to rotate an axle, a latching rotor attached to the axle and configured to rotate, and a pair of latching permanent magnets attached to the latching rotor. A north pole of a permanent magnet and a south pole of another permanent magnet of the pair are facing along a same direction.

According to another embodiment, there is a robot that includes a frame, a magnetic latching mechanism, a processor that controls the magnetic latching mechanism, and a power source for powering the processor and the magnetic latching mechanism. The magnetic latching mechanism uses permanent magnets for bonding or unbonding to another device.

According to still another embodiment, there is a method for bonding and debonding a first robot with a second robot. The method includes a step of providing the first and second robots at a given distance D, a step of reducing the distance D between the first and second robots, a step of bonding the first robot with the second robot due to attraction magnetic forces developed between a magnetic latching mechanism of the first robot and a magnetic latching mechanism of the second robot, a step of rotating a latching rotor of the magnetic latching mechanism of the first robot relative to a latching rotor of the magnetic latching mechanism of the second robot to generate a repelling magnetic force, and a step of unbonding the first robot from the second robot.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 illustrates various capabilities of permanent and active magnets;

FIGS. 2A and 2B show a robot having side faces that include corresponding magnetic latching mechanisms;

FIG. 3 shows the internal configuration of a robot and its magnetic latching mechanism;

FIGS. 4A to 4C show the components of a magnetic latching mechanism;

FIG. 5 is a flowchart of a method for bonding and unboding two robots having corresponding magnetic latching mechanisms;

FIGS. 6A and 6B show two magnetic latching mechanisms belonging to two different robots;

FIGS. 7A to 7D show how two robots bond and then unbond due to their magnetic latching mechanisms; and

FIG. 8 is a table indicating the various components used for a given robot having a magnetic latching mechanism.

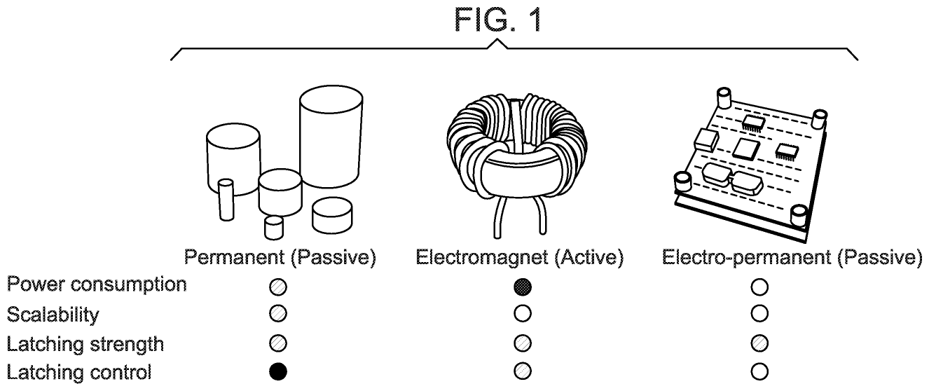

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to small robots (also called bots) that are capable of docking and undocking from each other. However, the invention is not limited to such embodiments, as other types of robots or devices (e.g., drones) may be provided with the magnetic latching mechanism discussed herein.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, there is a novel magnetic latching mechanism that achieves docking and undocking for permanent (also called passive because of its zero power consumption) magnets. In this embodiment, an indirect way for controlling the latching of the permanent magnets is achieved. The mechanism may use ultra-nano servo actuators for the undocking of the magnets. A generic purpose of this latching mechanism is to enable strong bond making and bond breaking abilities among the magnetic contacts in any given assembly that has latching components. In one application, the proposed mechanism is applied, as discussed later, in the specific application of programmable self-assembly devices, where small scale robots (in the cm range), called usBots, can autonomously interact and collaborate with each other to form a desired target assembly.

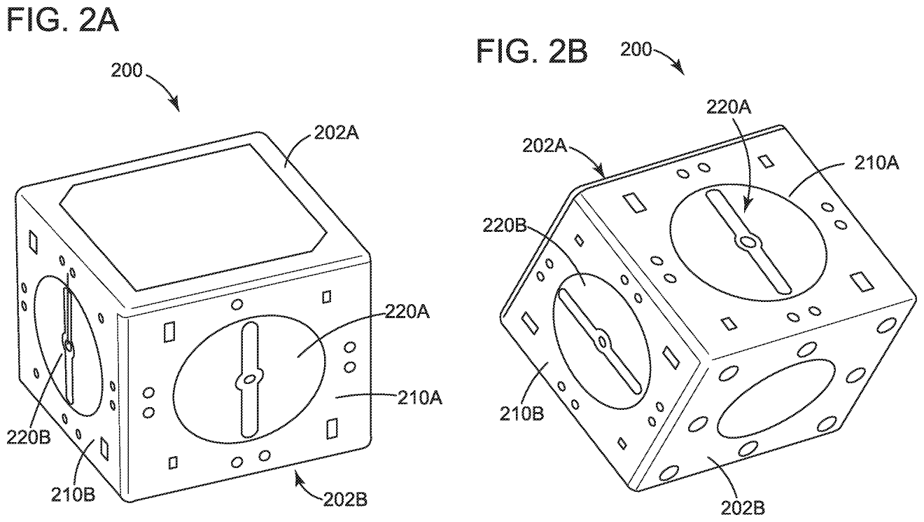

Details about this novel magnetic latching mechanism are now discussed. FIGS. 2A and 2B show a robot 200 being shaped as a cube. Other shapes may be used for the robot. Robot 200 has a top face 202A and a bottom face 202B, opposite to the top face 202A. Because the intention of this embodiment is not to change the robot's top and bottom faces (due to a change in the spatial orientation of the robot), the top and bottom faces do not have a magnetic latching mechanism.

Robot 200 also has four side faces 210A to 210D, only two of which are shown in FIGS. 2A and 2B. Each of these faces may have a corresponding magnetic latching mechanism 220A and 220B. While the embodiment discussed herein considers that each side face has a magnetic latching mechanism, one skilled in the art would understand that it is possible that only one, or only two or only three side faces of the robot may have the magnetic latching mechanism.

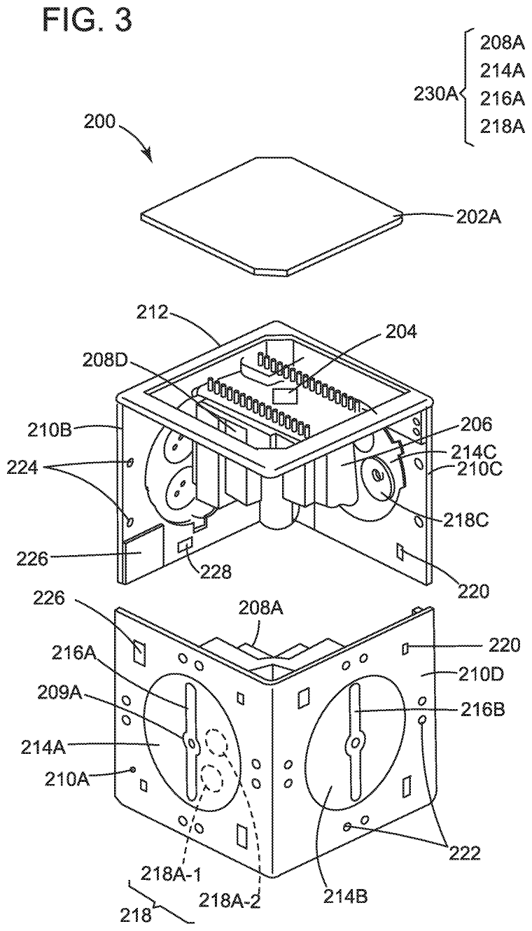

FIG. 3 shows the robot 200 being opened up so that various internal components are visible. This figure shows each of the faces 210A to 210D. In one application, a frame 212 may be used to support the side faces 210A to 210D but also the top and bottom faces 202A and 202B. The robot 200 includes a processor (e.g., a microcontroller) 204 located on a servo mount 206. Attached to the servo mount 206 (which may be a frame, bracket, etc.) are one or more servo-motors 208A and 208D. In this embodiment, each latching mechanism has its own servo-motor so that each latching mechanism operates independent of the other latching mechanism. Servo-motor 208A has an axle 209A that connects to a latching rotor 214A through a servo to rotor mount 216A. The rotor mount 216A may be attached directly to the latching rotor 214A. In one application, the latching rotor 214A has a groove in which the rotor mount fits. In still another application, the latching rotor has a cut through in which the rotor mount fits. In one embodiment, the axle 209A can be directly connected to the latching rotor 214A. If each side face 210A to 210D has a corresponding latching rotor, then each latching rotor is connected to a corresponding servo-motor for ensuring independent rotation of the latching rotors. Note that side face 210A, which hosts the latching rotor 214A, has a large hole centered within the side face, for receiving the latching rotor 214A. A small clearance is formed between the hole in the side face 210A and the latching rotor 214A so that the latching rotor can easily rotate.

Each latching rotor 214A has one or more pairs 218 of permanent magnets 218A-1 and 218-2 attached to it. The latching magnets 218A-1 and 218A-2 are attached on the back side of the latching rotor 214A and for this reason, the latching magnets 218A-1 and 218A-2 are illustrated with dashed lines in the figure. FIG. 3 shows a pair 218C of latching magnets attached to the back of the latching rotor 314C. As will be discussed later, the latching magnets attached to each latching rotor are provided in pairs. The servo-motor 208A, latching rotor 214A, rotor mount 216A and a pair of latching magnets 218A form the magnetic latching mechanism 230A.

FIG. 3 further shows one or more light emitting diodes (LED) 220. In one application, each side face 210 has a corresponding LED 220. The LED 220 may be used for inter-robot communication. As two different robots approach each other for docking, one or more alignment magnets 222 may be distributed over one or more of the side faces 210. For example, FIG. 3 shows each side face having four pairs of alignment magnets 222. The alignment magnets 222 are permanent small magnets and each pair has the corresponding magnets arranged so that one magnet of the pair has the north pole facing outward and the other magnet of the pair has the south pole facing outward. In this way, when two different side faces of two different robots are approaching each other, these alignment magnets force the robots to get aligned to each other. Note that these robots may have no means for moving from one point to another point. This feature would be discussed in more detail later.

FIG. 3 also shows side closure magnets 224 located on the inside of the side faces 210. The closure magnets may be permanent magnets and may come in pairs. These magnets may be magnetically attracted to the frame 212 so that there is no need for screws or other means for attaching the faces of the robot to its frame. Alternatively, the magnets from one side face may mate directly with magnets from an adjacent side face to form the body of the robot. An ambient light sensor 226 may be placed on one or more of the side faces 210. When this sensor receives light from the LED 220, it generates a signal that is transmitted to the processor 204. This is one way for two robots to exchange information, i.e., use light for transmitting one or more bits of information. Each processor 204 may store in a memory a table that translates each sequence of light signals into a command so that a meaningful communication between the robots can take place. The robot may also include a power source 228 (for example, a battery) for providing the necessary energy to the LED for generating light and to the processor for performing various commands and instructions. Note that the robot discussed herein has no locomotion. However, one skilled in the art would understand that a locomotion mechanism may be provided to each robot if so desired.

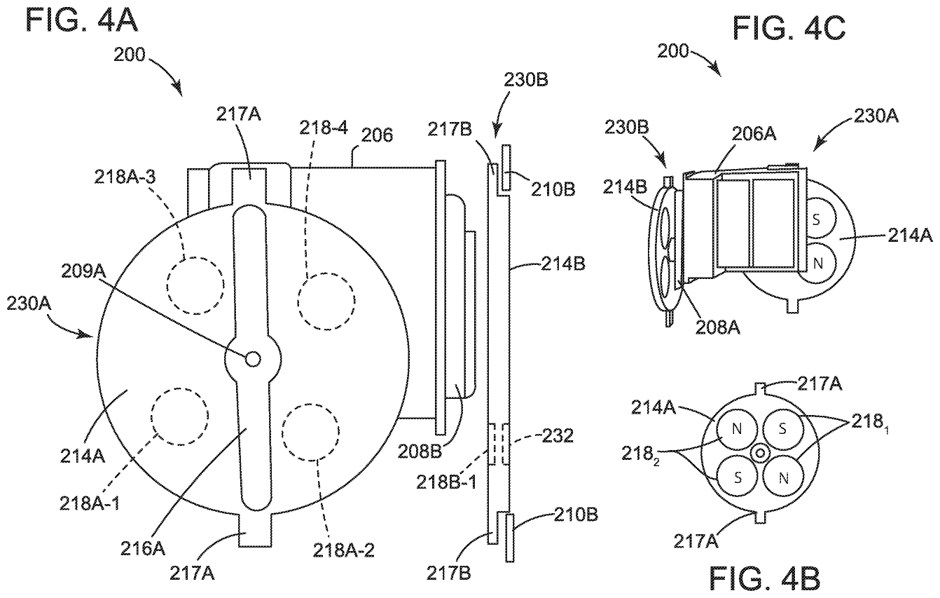

The magnetic latching mechanism 230A is shown in more detail in FIGS. 4A to 4C, which are now discussed. FIG. 4A shows the servo mount 206 and two magnetic latching mechanisms 230A and 230B. Note that the associated side faces of the latching mechanisms (each side face may have its own latching mechanism 230) are not shown in this figure for simplicity. However, if the side face 210B would be added in FIG. 4A, it would fit around the latching rotor 214B so that that mechanical brakes 217B extend behind the side face 210B. In other words, the mechanical brakes are not visible from outside when robot 200 is fully assembled. While the axle 209A, latching rotor 214A and rotor mount 216A are visible in the figure, the associated pairs of latching magnets are not visible, as they are attached behind the latching rotor 214A. However, the latching magnets 218A-1 to 218A-4 are shown with dash lines in the figure. FIG. 4B shows the back side of the latching rotor 214A and two pairs 218₁ and 218₂ of latching magnets. Note that each pair of latching magnets have the N and S poles opposite to each other and also the poles are facing toward the outside of the robot.

Both FIGS. 4A and 4B shows the latching rotor 214A having two mechanical brakes 217A. In one application, the latching rotor has only one mechanical brake. The mechanical brake may be a planar extension of the latching rotor, i.e., a tab. These mechanical brakes are used to ensure that a rotation of the latching rotor does not extend past a given angle, as discussed later. FIG. 4A also shows a profile of the latching rotor 214B, its mechanical brakes 217B and the corresponding servo-motor 208B, which rotates the latching rotor. Note that the latching rotor 214B may be rotated independent of the latching rotor 214A, as each latching rotor has its own servo-motor. The profile of the latching rotor 214B shows that the latching magnets 218B-1 are embedded into a thickness of the latching rotor. In one embodiment, a surface of the latching magnet is flush with a back side of the latching rotor 214B, or flush with a front side of the latching rotor 214B. In one application, all surfaces of the latching magnet are inside the latching rotor. In one application, a shielding layer 232 may be placed to separate the latching magnet 218B-1 from a mating magnet from another robot. FIG. 4C shows the device of FIG. 4A rotated by 180 degrees. In one application, the servo mount 206 may have a first part 206A, as illustrated in FIG. 4C, configured to hold only two magnetic latching mechanisms 230A and 230B and a second part (not shown but symmetrical to first part 206A) of the servo mount 206 may be configured to hold the other two magnetic latching mechanism. The two parts may be connected together to form the servo mount 206 and then they can be placed inside the frame 212.

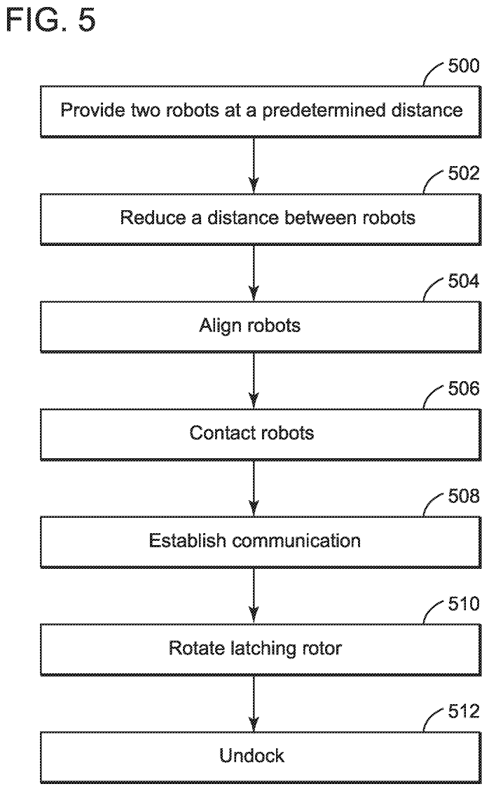

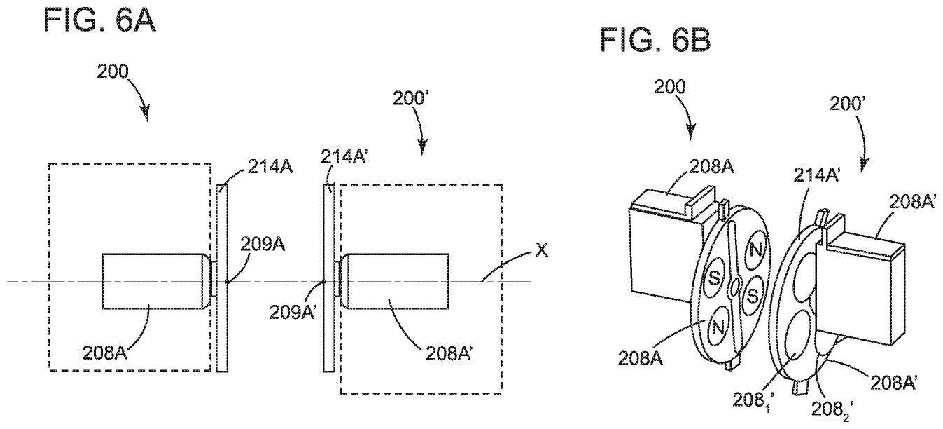

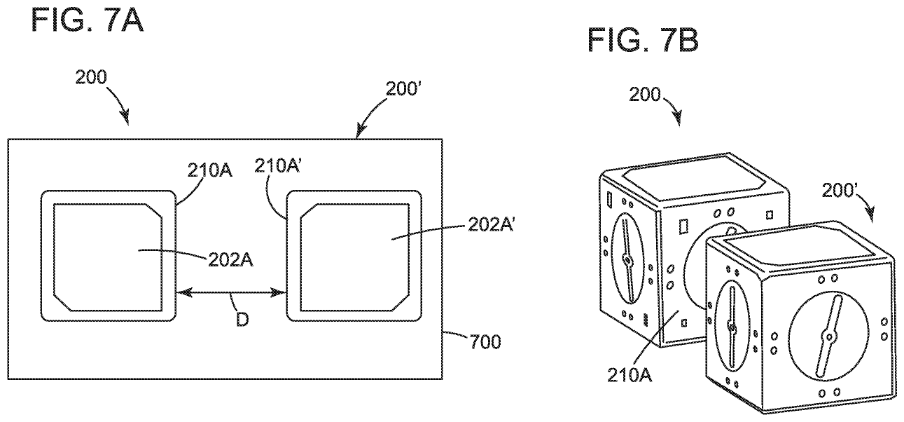

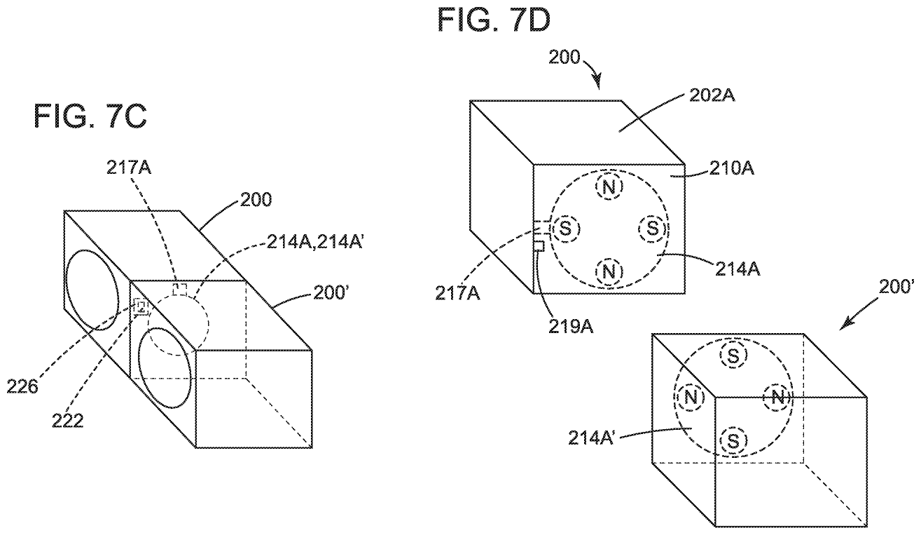

An interaction (docking and undocking) between the magnetic latching mechanisms of two different robots is now discussed with regard to FIG. 5. FIGS. 6A and 6B show only the latching rotors 214A and 214A′ of two different robots 200 and 200′ and their corresponding servo-motors 208A and 208A′. FIG. 6B also shows the latching rotor 214A′ having two pairs 218₁′ and 218₂′ of latching magnets distributed across the latching rotor 214A′ in a symmetric way. If the top and bottom faces and the side faces would be added to these two robots, the same configuration would look like what is shown in FIGS. 7A and 7B. The configuration shown in FIG. 7A has the two robots 200 and 200′ spaced apart by a distance D, which is large enough so that there is no substantial magnetic force acting on one robot because of the other. Thus, in step 500, two robots 200 and 200′ are provided on a surface of a platform 700 as shown in FIG. 7A. Note that the two robots do not have locomotion means. However, as already discussed above, one skilled in the art would know how to add locomotion to these robots if necessary. The platform 700 may move (e.g., tilt or shake) so that the distance D may vary. If the distance D increases, nothing happens with the two robots. However, if the distance D decreases in step 502, the magnetic force (attraction or repulsion) between the two robots starts to increase.

Supposing that the two latching rotors are oriented so that each latching magnet from latching rotor 214A is facing an opposite magnetic pole of the corresponding latching magnet of latching rotor 214A′, as illustrated in FIG. 6B, then a magnetic force between the two latching rotors becomes stronger and the two robots start to move toward each other, due to this attraction force. Note that even if the two latching rotors are not perfectly aligned, as the two rotors get closer and closer, they automatically align to each other in step 504 because of the alignment magnets 222 shown in FIG. 3. The alignments magnets 222 force the two latching rotors 214A and 214A′, and implicitly the two side faces 210A and 210A′ that host the latching rotors to align to each other. In one application, the alignment action means that the axles 209A and 209A′ of each servo-rotor 208A and 208A′, respectively, are substantially (i.e., about 10%) extending along a same axis X, as shown in FIG. 6A.

In step 506, the two robots get in contact with each other due to the attraction forces generated by the latching magnets. In fact, the two latching rotors 214A and 214A′ may contact each other as shown in FIG. 7C. In this state (the docked state), the latching magnets from one latching rotor are fully aligned with the latching magnets from the other latching rotor and each pole of each latching magnet is directly facing (with a small gap to be discussed later) an opposite pole of a latching magnet from the other robot. Further, the latching magnets of each latching rotor are symmetrically distributed along their latching rotor and the two latching rotors of the two robots are substantially identical so that the latching magnets from the two latching rotors are aligned to maximize the magnetic force between them. In other words, the distribution of the latching magnets of a latching rotor of a first robot is a mirror version of the distribution of the latching magnets of a latching rotor of a second robot. In one embodiment, this configuration is repeated for each side face of each robot.

At this time, the light emitting sensor 220 from one robot is directly facing the light ambient sensor 226 of the other rotor so that, in step 508, signals and/or commands can be transmitted from one robot to another. Thus, communication between the two robots may be established in step 508. However, one skilled in the art would understand that this communication is not necessary for docking or undocking the two robots. In one application, the processor of one robot can communicate via the light emitting sensor 220 and the light ambient sensor 226 with the processor of the other robot. Also note that FIGS. 5 to 7D describe the docking and undocking of two robots 200 and 200′. However, the same steps may be applied to plural robots so that a chain of robots are docked together and communication between plural robots may be established through the light emitting sensors and the light ambient sensors discussed above.

When the processor of one robot, e.g., robot 200, decides to undock from the other robot 200′, the processor 204 instructs the corresponding servo motor 208A to rotate in step 510 the latching rotor 214A, with a given angle relative to its axle 209A, and implicitly, relative to the latching rotor 214A′. If the rotation angle is selected to be 90°, then, the latching magnets of one robot become again aligned with the latching magnets of the other robot, but this time, each pole of the first robot is facing a same pole of the opposite robot, which means that a repealing magnetic force appears between the two side faces 214A and 214A′ of the robots 200 and 200′. Because the latching magnets are selected to have stronger magnetic forces between them than the alignments magnets, the two robots undock in step 512 due to the large repealing forces. At this time the distance between the two side faces of the two robots increases as illustrated in FIG. 7D and separation of the two robots is achieved.

Note that FIG. 7C shows the braking mechanism 217A of the latching rotor 214A pointing North while FIG. 7D shows the same braking mechanism 217A pointing West. This denotes that the latching rotor 214A has rotated with 90 degrees. FIG. 7D also shows a stop break 219A attached to the back of the side face 210A and this stop break stops the rotation of the braking mechanism 217A in case that the servo-motor 208A fails to rotate the latching rotor by exactly 90 degrees. In one embodiment, if the two robots 200 and 200′ agree through the communication established in step 508 to both undock, it is possible that each robot turns its latching rotor with 45 degrees in opposite directions, so that a total relative rotation of one latching rotor relative to the other is about 90 degrees, enough to generate the repealing magnetic forces discussed above. One skilled in the art would understand that even a rotation smaller than 90 degrees (e.g., 45 degrees or larger) may achieve the undocking of the robots.

The repulsive or attraction magnetic force used to dock and undock the robots is now discussed. If a ferrous object is in close vicinity (from a few mm to few cm, depending on the object) to a permanent magnet, there exists a force of attraction between the object and the magnet. Mathematically, the force of attraction of a magnet at its air gap (the space around the poles of a magnet) is given by Maxwell equation:

$$F = \frac{{B}^{2} A}{2 {μ}_{0}} ,$$

where F is the force (N), A is the surface area of the pole of the magnet (m²), B is the magnetic flux density (T), and μ₀ is the permeability of the medium (air in this case).

Thus, if the target is a magnet itself, then there exists either a force of attraction or repulsion between the two magnets. The nature of this force depends on the polarity of the two approaching magnets. Nevertheless, this force is almost twice (in case of neodymium magnets) as compared to the magnetic force given by the above equation. This concept in used in the above embodiments to achieve programmable self-assembly in small robots. As shown in FIGS. 3 and 7D, in the latching rotor, the magnetic polarities (or poles) of adjacent latching magnets, along the circumference of the latching rotor, are kept to alternate from one magnet to another one.

In this way, a complete reversal of all latching magnets' polarity can be achieved by a 90 degrees rotation of one latching rotor relative to another latching rotor, as illustrated in FIGS. 7C and 7D. Note that the rotation can be either clockwise or counter-clockwise. This concept has been proven to be very effective.

Thus, after two robots approach each other as shown in FIGS. 7A and 7B, they are going to be attracted towards each other with a force roughly eight times the pull of a single latching magnet (assuming that each latching rotor has four individual latching magnets). This bond formed among the robots' side faces is strong and yet not permanent because the bond can be easily (i.e., with low energy) be undone by using the servo-motor to perform a 90 degrees rotation of one latching rotor, by either of the robots or a 45 degrees rotation of each of the robots.

One matter associated with this magnetic latching mechanism is that the action of bond breaking (i.e., the undocking) by revolving either or both of the latching rotors require a mechanism that produces a high torque. In one embodiment, due to small size constraints on the robot design, and difficulty of finding small size and high torque servos, it is possible to introduce a shielding layer on either sides of the bonding faces of the latching magnets. This shielding layer may have various sizes, for example, 1 mm thickness. The shielding layer (for example, plastic layer) decreases the magnetic force of attraction to about 8 N in total. At this level, the bond between two latching rotors facing each other and in contact with each other can be broken by a 90 degrees rotation achieved with the smallest high torque servo commercially available (e.g., HS-35HD servo motor). Note that FIG. 4A shows such a shielding layer 232 placed in front of the latching magnet 218B-1. The shielding layer 232 may be made flush with the front surface of the latching rotor 214B. In one embodiment, the shielding layer 232 and the latching rotor may be made of the same material. In another embodiment, the shielding layer 232 is made integral with the latching rotor 214B. However, it is possible to place the shielding layer 232 over the latching rotor or directly over the latching magnets.

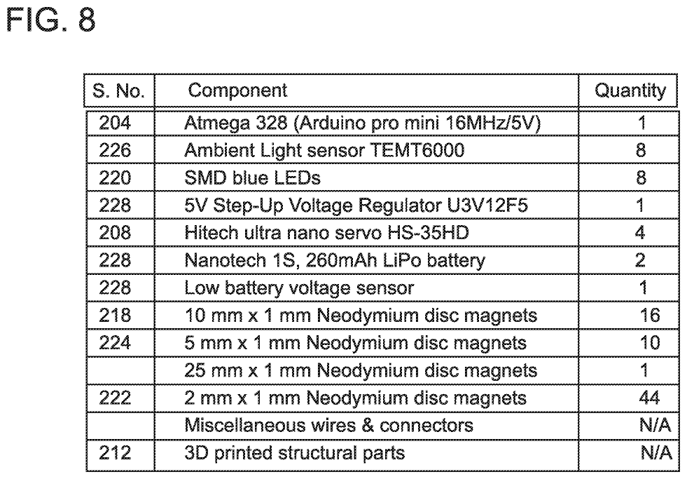

In one embodiment, the robot shown in FIG. 3 may be entirely, uniquely, designed and 3D printed with the components list illustrated in FIG. 8. This specific design includes the four side faces 210 and two stationary top and bottom faces 202. As previously discussed, the robot 200 shown in FIG. 3 is not capable of self-locomotion and hence, an external actuation platform 700 is used (see FIG. 7A) for its movement and interactions with other similar robots. Note that the magnetic latching mechanism 230 disclosed herein is completely self-assisting, i.e., it can pull the robots close as well as push them away depending on the latching rotor's orientation, which can be controlled by processor 204 and servo-motor 208. To ensure reliability and consistency in bonding/de-bonding action, the latching rotor 214 has two mechanical braking arms 217A along its diameter to avoid any over rotation that might be caused by a servo slip, for instance.

One or more of the advantages of the embodiments presented above is now discussed. The robot shown in FIG. 3 may be scaled down to be a compact mechatronic design having dimensions of about 5×5×5 cm and a weight of only 95 g. The bond strength achieved between two robots 200 is high compared to EPMs of similar size (4×0.58 kg pull on attraction mode).

The experiments performed with the robot 200 reveal that for such a small mechanism, the forces required to dismantle the bond are impressive. The following peak values of the force tests were measured. For side face—side face attraction the measured force was 8.7 N. Note that no other robot of this size with EPMs has a stronger bond strength to the knowledge of the inventors. For side face—side face repulsion, the measured force was 6.9 N. Again, no other robot of this size with EPMs have a strength greater than this for bond break/repulsion. For side face-side face slide, the maximum measured force was 4.3 N.

The torque required to break the bond was measured to be 0.065 Nm. This is in accordance with the design of the robot, i.e., the placement of the latching magnets relative from the center of rotation of the latching rotor and the plastic shielding in between the contact faces. This value of torque is quite high given the small size of the mechanism. Also, the value of this torque is below the maximum allowed torque of the servo used (0.078 Nm), which makes it extremely reliable to use.

Three modes of operation are possible for the robot 200: (1) attach (bond formation), (2) detach (bond breaking), and (3) repel (avoidance, which is achieved when the latching magnets of the two robots are aligned but have the same polarities facing each other). EPMs do not have this third mode, the repel mode. This avoidance feature is unique to the design shown in the figures and this feature removes the need of local communication between the neighboring robots.

The robot 200 discussed above consumes less power than an EPM (of comparable size/strength). This is so because there is no power used for bond formation, and there is little energy used for bond breaking. Each ultra-nano servo draws a peak current of 0.36 A at a rotation stall (which doesn't happen during normal operation) and the idle state current is 0.008 A, which is less on average than each of the EPMs that need a peak current>1 A during activation or deactivation. Further, the robot uses zero power for avoidance, i.e., instantaneous repelling of other robots.

The robot 200 also has the capability of self-alignment of the faces and the contacts. There is no additional sensing or actuation force required for this feature, i.e., the bond formation and bond breaking are self-assisted. Two approaching robots can self-align their faces to make a bond or repel each other depending on the orientation of the face magnets. Also, the bond breaking is self-assisted. It does not only break the bond, but the generated repulsion force is enough to push two robots in opposite directions.

The magnetic latching mechanism discussed with regard to robot 200 is highly scalable, i.e., the same concept can be extended to bigger magnets and higher torque servos as well for bigger and stronger bonds in latching components. The joints can also be used for collective robots locomotion in future. Also, those skilled in the art would understand that the above discussed magnetic latching mechanism may be used not only with robots, but also with other devices, e.g., drones, cars, trains, planes, etc. The discussed magnetic latching mechanism may be used with various electrical components, home appliances or in various buildings for achieving the required docking or undocking of objects.

The disclosed embodiments provide methods and mechanisms for docking or bonding and undocking or unbonding two or more robots using a magnetic latching mechanism. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A magnetic latching mechanism comprising:
a servo-motor configured to rotate an axle;
a latching rotor attached to the axle and configured to rotate; and
a pair of latching permanent magnets attached to the latching rotor,
wherein a north pole of a permanent magnet and a south pole of another permanent magnet of the pair are facing along a same direction.

2. The magnetic latching mechanism of claim 1, further comprising:
a braking mechanism configured to stop a rotation of the latching rotor after a 90 degrees rotation.

3. The magnetic latching mechanism of claim 2, wherein the braking mechanism includes a tab and a stop break, and wherein the tab is attached only to the latching rotor.

4. The magnetic latching mechanism of claim 1, further comprising:
a processor for controlling the servo-motor; and
a power source for powering the servo-motor and the processor.

5. The magnetic latching mechanism of claim 1, further comprising:
a rotor mount directly attached to the axle,
wherein the rotor mount attaches to the latching rotor.

6. A robot comprising:
a frame;
a magnetic latching mechanism;
a processor that controls the magnetic latching mechanism; and
a power source for powering the processor and the magnetic latching mechanism,
wherein the magnetic latching mechanism uses permanent magnets for bonding or unbonding to another device.

7. The robot of claim 6, wherein the magnetic latching mechanism comprises:
a servo-motor configured to rotate an axle;
a latching rotor attached to the axle and configured to rotate; and
a pair of latching permanent magnets attached to the latching rotor,
wherein a north pole of a permanent magnet and a south pole of another permanent magnet of the pair are facing along a same direction.

8. The robot of claim 7, wherein the magnetic latching mechanism further comprises:
a braking mechanism configured to stop a rotation of the latching rotor after a 90 degrees rotation.

9. The robot of claim 8, wherein the braking mechanism includes a tab and a stop break, wherein the tab only is attached to the latching rotor.

10. The robot of claim 7, further comprising:
a side face which is attached to the frame, the side face having a hole in which the latching rotor is located.

11. The robot of claim 6, further comprising
a light emitting device attached to a side face.

12. The robot of claim 11, further comprising:
alignment permanent magnets located on the side face and configured to align the side face with a corresponding mating face of the another robot.

13. The robot of claim 12, further comprising:
a light detecting sensor located on the side face and configured to detect light.

14. The robot of claim 13, wherein the processor uses the light emitting device and the light detecting sensor for communicating with another robot.

15. The robot of claim 6, wherein the processor instructs the servo-motor to rotate the latching rotor by 90 degrees.

16. A method for bonding and debonding a first robot with a second robot, the method comprising:
providing the first and second robots at a given distance D;
reducing the distance D between the first and second robots;
bonding the first robot with the second robot due to attraction magnetic forces developed between a magnetic latching mechanism of the first robot and a magnetic latching mechanism of the second robot;
rotating a latching rotor of the magnetic latching mechanism of the first robot relative to a latching rotor of the magnetic latching mechanism of the second robot to generate a repelling magnetic force; and
unbonding the first robot from the second robot.

17. The method of claim 16, wherein latching permanent magnets of the latching rotor of the first robot are magnetically attracted by latching permanent magnets of the latching rotor of the second robot during the step of bonding.

18. The method of claim 17, wherein the step of rotating makes the latching permanent magnets of the latching rotor to change their spatial positions so that the latching permanent magnets of the latching rotor of the first robot repeal the latching permanent magnets of the latching rotor of the second robot during the step of unbonding.

19. The method of claim 16, wherein the latching permanent magnets of the latching rotor of the first robot are symmetrically distributed over the latching rotor, which is rotated by a servo-motor.

20. The method of claim 19, wherein the latching permanent magnets of the latching rotor of the second robot are symmetrically distributed over the latching rotor, which is rotated by a servo-motor, and the latching permanent magnets of the first robot have the same distribution as the latching permanent magnets of the second robot.
